(19) United States
(12) Patent Application Publication
(10) Pub. No.: US 2004/0147662 A1
(43) Pub. Date: Jul. 29, 2004

(54) Pourable anti-settling thickening agent

(76) Inventor: Wayne Mattingly, Louisville, KY (US)

Correspondence Address: SUD-CHEMIE INC., 1600 WEST HILL STREET, LOUISVILLE, KY, 40210, US

(21) Appl. No.: 10/756,595

(22) Filed: Jan. 13, 2004

Related U.S. Application Data
(60) Provisional application No. 60/440,966, filed on Jan. 17, 2003.

(51) Int. Cl. C08K 5/01

(52) U.S. Cl. 524/484; 524/543

(57) ABSTRACT

The present development relates to an improved rheological additive for coating compositions comprising an aromatic organic solvent and an oxidized copolymer wax. An exemplary wax would be an oxidized ethylene-vinylacetate copolymer. The solvent is present at concentrations of from about 60 wt % about 90 wt % and the wax is present at concentrations of from about 10 wt % to about 40 wt %.

### CROSS-REFERENCE TO RELATED APPLICATIONS

The present application is related to U.S. Provisional Application Serial No. 60/440,966 filed on Jan. 17, 2003 and incorporated herein in its entirety by reference.

### BACKGROUND

The present development relates to an improved rheological additive for coating compositions. Specifically, a rheological additive is described that comprises an organic solvent at concentrations of up to about 80 wt % and a hydrocarbon wax thickener at concentrations of at least about 20 wt %. The resulting product is a viscous liquid that can be used in coating compositions to provide viscosity at very low shear rates.

It is well known in the art that rheological thickeners can be added to paints and similar coatings to modify the viscosity of the coating and to maintain the suspension of pigments used, for example, to give color to the coating. Historically, these rheological thickeners were prepared by combining organic solvents with about 25 wt % to about 40 wt % oxidized polyethylene wax to form a solid paste. The paste hardness increased with higher wax concentrations. However, the resulting thickeners were difficult to handle and did not disperse well in the coatings.

By adding sulfated castor oil with the oxidized polyethylene wax and processing the material through a scraped-surface heat exchanger, softer high solids (30 wt % to about 40 wt %) wax dispersions can be prepared. The resulting additive does disperse more easily in coatings than the pastes, but the additive has a grease-like consistency and is not pourable. Pourable additives that are easier to handle and that disperse in the coatings rapidly have been prepared by combining relatively low concentrations of oxidized polyethylene wax with organic solvents and, optionally, sulfated castor oil or similar surfactants. A scraped-surface heat exchanger is used for cooling the dispersion during the manufacturing process. Although easy to use, these pourable additives typically have a total solids content of about 20 wt %, wherein the wax provides only a portion of the total solids, commonly in the range of about 17 wt %, with the balance of the solids resulting from byproducts such as sulfated castor oil.

### SUMMARY OF THE INVENTION

The present development relates to an improved rheological additive for coating compositions. The rheological additive comprises an organic solvent and a hydrocarbon wax thickener, where the hydrocarbon wax is an oxidized ethylene copolymer absent additional surfactants. The oxidized ethylene copolymer can be present at a range of from about 10 wt % to about 40 wt %. In a preferred embodiment, the organic solvent comprises about 80% and the hydrocarbon wax comprises about 20% of the additive composition. The processing conditions can affect the quality of the resultant rheological additive.

### DETAILED DESCRIPTION OF THE PREFERRED EMBODIMENT

Rheological thickeners are added to paints and similar coatings to modify the viscosity of the coating and to maintain the suspension of pigments used, for example, to give color to the coating. The most preferable thickeners demonstrate both anti-sag and anti-settling properties while also demonstrating good flow properties, or thickeners that can deliver a fairly high viscosity at a very low shear rate. However, the viscosity needed to maintain the suspension can create problems when the coating is to be applied to a surface. In the latter case, a balance must be achieved so that the product has a high enough viscosity to prevent sag, but the product must also be able to flow adequately to allow the coating to be easily and evenly dispersed.

The rheological additive of the present invention is intended for use in paints and similar coatings. The additive comprises an aromatic organic solvent present at a concentration of from about 60% by weight to about 90% by weight and a hydrocarbon wax present at a concentration of about from 10% by weight to about 40% by weight. The organic solvent are preferably limited to aromatic compounds and not aliphatic compounds. Exemplary waxes that can be used, without limitation, include oxidized copolymers such as or an oxidized ethylene-vinylacetate copolymer. It has been surprisingly found that by using an oxidized ethylene copolymer a pourable additive is formed without the need for additional surfactants even at relatively high concentrations of wax addition. Thus, the additive of the present invention comprises total solids concentration directly due to the hydrocarbon wax, and not contaminated with surfactant byproducts.

The additive is prepared by quickly adding the wax to the solvent and carefully maintaining the reaction temperature for a predetermined period of time. The temperature is then slowly decreased and the mixture is fed through a scraped-surface heat exchanger, such as a Votator, before packaging.

In a representative embodiment, a rheological additive comprising 80 wt % xylene and 20 wt % oxidized ethylene-vinylacetate copolymer (available from Honeywell International, Morristown, N.J., and identified as A-C 645 P) is prepared such that the resulting product has a density of about 7.47. The additive is prepared by charging the xylene into a reaction tank that has been cleaned and dried with nitrogen. The xylene is either added by vacuum or it can be pumped in using an air pump. A nitrogen sparge is started and high agitation. The wax is quickly charged into the xylene through a funnel or manway. When the wax is completely charged, the reactor is sealed and vented, and is then heated to a temperature of from about 100° C. to about 115° C. The elevated temperature is maintained until the wax is completely melted and the mixture is homogeneous. A typical reaction time at the elevated temperature is about 30 minutes. When the mixture is homogeneous, the temperature is allowed to slowly decrease to a temperature in the range of from about 70° C. to about 80° C. using a cooling water heat exchanger. The temperature should decrease from the 100° C. reaction temperature to about 70° C. within about 2 hours. After the mixture reaches about 70° C., the agitation is decreased and the mixture is fed to a Votator, or similar scraped-surface heat exchanger, having an outlet temperature set within the temperature range of from about 15° C. to about 40° C. The product exits the Votator into drums.

The rheological additive of the present invention can be used in paints and other coating compositions. The additive differs from the prior art by being formulated and prepared such that the additive is pourable but with a sufficiently high wax content that the additive can provide viscosity to the coating compositions at very low shear rates, thereby providing anti-settling characteristics to the coating compositions. The additive of the present invention is pourable without the need for adjuncts, such as sulfated castor oil or other surfactants. Further, the additive of the present invention as prepared with the oxidized copolymer demonstrates greater efficiency in a coating formulation than additives prepared with oxidized polyethylene wax. On a pound-per-pound active basis, the oxidized copolymer formulation has been observed to yield higher low-shear viscosity readings than the oxidized polyethylene wax. This can result in improved anti-settling and anti-sagging properties in the coating product.

It is understood that the composition of the rheological additive and the specific processing conditions may be varied within limits without exceeding the scope of this development.

What is claimed is:

1. A rheological additive consisting essentially of an aromatic organic solvent and an oxidized copolymer hydrocarbon wax.

2. The additive of claim 1 wherein said hydrocarbon wax is an oxidized ethylene-vinylacetate copolymer.

3. The additive of claim 1 wherein said organic solvent is xylene.

4. The additive of claim 1 wherein said organic solvent is present at a concentration of from about 60% by weight to about 90% by weight and said oxidized copolymer hydrocarbon wax present at a concentration of from about 10% by weight to about 40% by weight.

5. The additive of claim 4 wherein said organic solvent is present at a concentration of about 80% by weight and said oxidized copolymer hydrocarbon wax present at a concentration of about 20% by weight.

6. A rheological additive comprising an aromatic organic solvent and an oxidized copolymer hydrocarbon wax.

7. The additive of claim 6 wherein said hydrocarbon wax an oxidized ethylene-vinylacetate copolymer.

8. The additive of claim 6 wherein said organic solvent is present at a concentration of from about 60% by weight to about 90% by weight and said oxidized copolymer hydrocarbon wax present at a concentration of from about 10% by weight to about 40% by weight.

9. The additive of claim 8 wherein said organic solvent is present at a concentration of about 80% by weight and said oxidized copolymer hydrocarbon wax present at a concentration of about 20% by weight.

10. The additive of claim 6 wherein the additive is prepared by quickly adding said wax to said solvent to form a mixture, and carefully maintaining a predetermined reaction temperature for a predetermined period of time, and then slowly decreasing the temperature and feeding the mixture through a scraped-surface heat exchanger.

11. The additive of claim 6 wherein the additive is prepared by charging said organic solvent into a reaction tank that has been cleaned and dried with nitrogen, and while maintaining a nitrogen sparge and high agitation quickly charging said wax into said solvent, and then sealing and venting said reactor and heating to a temperature of from about 100° C. to about 115° C. and maintaining the temperature until the wax is completely melted and a homogeneous mixture is formed, and then slowly decreasing the temperature to between about 70° C. and about 80° C., and then decreasing the agitation and feeding the mixture to a scraped-surface heat exchanger having an outlet temperature set at from about 15° C. to about 40° C.

12. The additive of claim 11 wherein the temperature is decreased from about 100° C. to about 80° C. by using a cooling water heat exchanger.

13. The additive of claim 11 wherein the temperature decrease occurs over a period of about two hours.

14. A rheological additive comprising an aromatic organic solvent present at a concentration of from about 60% by weight to about 90% by weight and an oxidized copolymer hydrocarbon wax present at a concentration of from about 10% by weight to about 40% by weight.

15. The additive of claim 14 wherein said organic solvent is xylene.

16. The additive of claim 14 wherein said hydrocarbon wax is an oxidized ethylene-vinylacetate copolymer.

17. The additive of claim 14 wherein said organic solvent is xylene and is present at a concentration of up to about 80% by weight and said oxidized copolymer hydrocarbon wax is an oxidized polyethylene wax copolymer present at a concentration of at least about 20% by weight.

18. The additive of claim 14 wherein said organic solvent is xylene and is present at a concentration of up to about 80% by weight and said oxidized copolymer hydrocarbon wax is an oxidized ethylene-vinylacetate copolymer present at a concentration of at least 5 about 20% by weight.

19. The additive of claim 14 wherein the additive is prepared by charging said organic solvent into a reaction tank that has been cleaned and dried with nitrogen, and while maintaining a nitrogen sparge and high agitation quickly charging said wax into said solvent, and then sealing and venting said reactor and heating to a temperature of from about 100° C. to about 115° C. and maintaining the temperature until the wax is completely melted and a homogeneous mixture is formed, and then slowly decreasing the temperature to between about 70° C. and about 80° C., and then decreasing the agitation and feeding the mixture to a scraped-surface heat exchanger having an outlet temperature set at from about 15° C. to about 40° C.

20. The additive of claim 19 wherein the temperature decrease occurs over a period of about two hours.
